(19) United States
(12) Patent Application Publication
(10) Pub. No.: US 2025/0113284 A1
(43) Pub. Date: Apr. 3, 2025

(54) BASE STATION APPARATUS AND TERMINAL APPARATUS

(71) Applicant: JVCKENWOOD Corporation, Yokohama-shi, Kanagawa (JP)

(72) Inventor: Tomonori NAGAHAMA, Yokohama-shi (JP)

(21) Appl. No.: 18/978,022

(22) Filed: Dec. 12, 2024

Related U.S. Application Data
(63) Continuation of application No. PCT/JP2023/018829, filed on May 19, 2023.

(30) Foreign Application Priority Data
Jun. 22, 2022 (JP) 2022-100089

(51) Int. Cl. H04W 40/08; H04W 64/00; H04W 88/04

(52) U.S. Cl. CPC H04W 40/08; H04W 64/00; H04W 88/04

(57) ABSTRACT

A state management unit in a base station apparatus transmits an information request signal requesting terminal information to a plurality of terminal apparatuses from a communication unit and receives, using the communication unit, the terminal information from the terminal apparatus in response to the information request signal, the terminal information including information on a transmission power and position information on the terminal apparatus. The role determination unit determines the terminal apparatus having a transmission power larger than a preset threshold value and located in a predetermined area within a preset communication area of a host base station apparatus to have a forwarding role for forwarding a signal, based on the received terminal information. The role determination unit transmits, from the communication unit, a role change signal notifying the terminal apparatus, whose role is determined to be the forwarding role, that the forwarding role is assigned to the terminal apparatus.

### CROSS-REFERENCE TO RELATED APPLICATION

This application is a continuation of application No. PCT/JP2023/018829, filed on May 19, 2023, and claims the benefit of priority from the prior Japanese Patent Applications No. 2022-100089, filed on Jun. 22, 2022, the entire contents of which are incorporated herein by reference.

### BACKGROUND

### 1. Field

The present disclosure relates to a base station apparatus and a terminal apparatus.

### 2. Description of the Related Art

A technology adapted to a telephone system consisting of a base unit and an extension unit is known, wherein the system is configured to allow the base unit and the extension to communicate using a charger as a repeater when the reception status of a reception signal received by the base unit from the extension unit deteriorates (for example, see Patent Document 1).
[Patent Literature 1] JP2014-209702

In the technology of Patent Literature 1, a predetermined charger is used as a repeater. Meanwhile, in a system in which a plurality of movable terminal apparatuses perform wireless communication via a base station, one of the terminal apparatuses may have a role for forwarding to allow a signal received by the terminal apparatus from the base station to be forwarded to a further terminal apparatus outside the communication area of the base station. In such a system, it is desirable to determine a terminal apparatus that assumes a role of forwarding depending on the situation.

### SUMMARY

A base station apparatus according to an embodiment includes: a communication unit that communicates wirelessly with each of a plurality of terminal apparatuses; a state management unit that manages terminal information on each of the plurality of terminal apparatuses; and a role determination unit that determines a role of the terminal apparatus. The state management unit: transmits an information request signal requesting terminal information to the plurality of terminal apparatuses from the communication unit; receives, using the communication unit, the terminal information from the terminal apparatus in response to the information request signal, the terminal information including information on a transmission power and position information on the terminal apparatus; and identifies a particular terminal apparatus likely located outside a communication area, based on past position information on the terminal apparatus from which the terminal information is not received in response to the information request signal. The role determination unit: determines, from among the plurality of terminal apparatuses, the terminal apparatus having a transmission power larger than a preset threshold value and located in a predetermined area within a preset communication area of a host base station apparatus to have a forwarding role of forwarding a signal, based on the received terminal information; and transmits, from the communication unit, a role change signal notifying the terminal apparatus, whose role is determined to be the forwarding role, that the forwarding role is assigned to the terminal apparatus.

Optional combinations of the aforementioned constituting elements, and implementations of the embodiments in the form of methods, apparatuses, systems, recording mediums, and computer programs may also be practiced as incremental modes of the embodiments.

### BRIEF DESCRIPTION OF THE DRAWINGS

FIG. 1 shows a configuration of the communication system of the first embodiment.

FIG. 2 shows a configuration of the base station apparatus of FIG. 1.

FIG. 3 shows a configuration of the terminal apparatus of FIG. 1.

FIG. 4 shows a data structure of a terminal state table maintained in the storage unit of the base station apparatus of FIG. 2.

FIG. 5 shows a data structure of a forwarding destination state table maintained in the storage unit of the first terminal apparatus of FIG. 1 having the forwarding role.

FIG. 6 is a sequence chart showing a sequence of steps for communication in the communication system of FIG. 1.

FIG. 7 is a sequence chart showing a sequence of steps, following FIG. 6, for communication in the communication system.

FIG. 8 is a sequence chart showing a sequence of steps, following FIG. 7, for communication in the communication system.

FIG. 9 is a sequence chart showing a sequence of steps, following FIG. 8, for communication in the communication system.

FIG. 10 is a sequence chart showing a sequence of steps, following FIG. 9, for communication in the communication system.

FIG. 11 is a flowchart showing the process in the base station apparatus of FIG. 1.

FIG. 12 is a flowchart showing the process, following FIG. 11, in the base station apparatus.

FIG. 13 is a flowchart showing the process in the terminal apparatus of FIG. 1.

FIG. 14 is a flowchart showing the process, following FIG. 13, in the terminal apparatus.

FIG. 15 is a flowchart showing the process, following FIG. 13, in the terminal apparatus.

FIG. 16 is a flowchart showing a forwarding process in the terminal apparatus having the forwarding role.

FIG. 17 shows a configuration of the communication system of the second embodiment.

### DETAILED DESCRIPTION

The invention will now be described by reference to the preferred embodiments. This does not intend to limit the scope of the present invention, but to exemplify the invention.

### First Embodiment

A brief summary will be given before describing the first embodiment in specific details. The first embodiment relates to a business wireless system including a plurality of terminal apparatuses and a base station apparatus. The terminal apparatus performs wireless communication with a further terminal apparatus via the base station apparatus. In a situation where the first terminal apparatus and the second terminal apparatus are located in the communication area of the base station apparatus and the third terminal apparatus is located outside the communication area, for example, an audio signal transmitted by the second terminal apparatus is received by the first terminal apparatus via the base station apparatus but is not received by the third terminal apparatus. To cause the third terminal apparatus outside the communication area to receive the audio signal in such a situation, it is ensured in this embodiment that the base station apparatus acquires the transmission power and position information on the terminal apparatus and determines the first terminal apparatus, for which the information satisfies a predetermined condition, to be a forwarding terminal. The first terminal apparatus thus determined forwards the audio signal received from the base station apparatus to the third terminal apparatus.

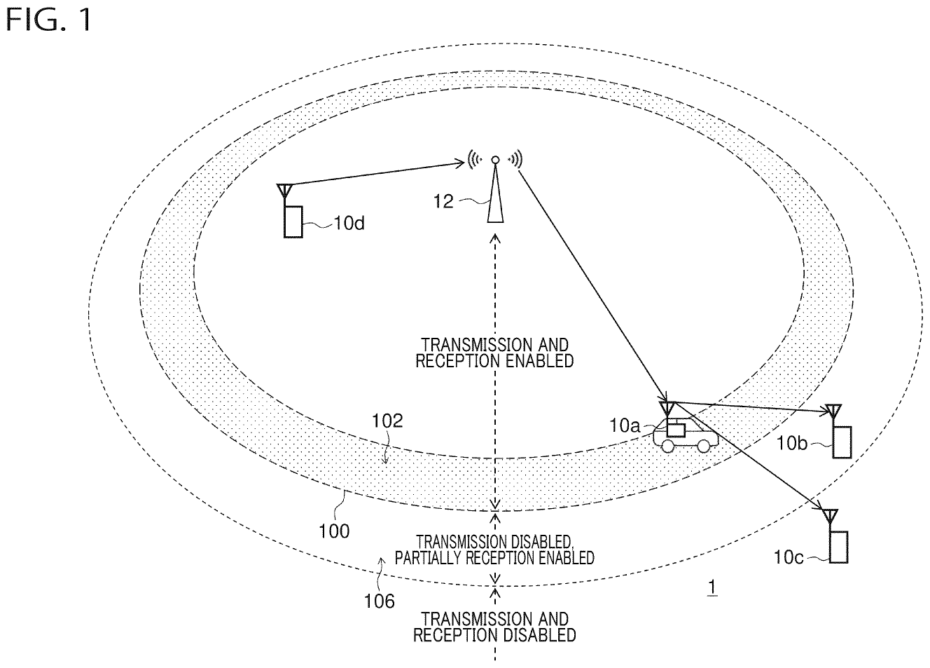

FIG. 1 shows a configuration of the communication system 1 of the first embodiment. The communication system 1 includes a first terminal apparatus 10a, a second terminal apparatus 10b, a third terminal apparatus 10c, a fourth terminal apparatus 10d, and a base station apparatus 12.

The first terminal apparatus 10a to the fourth terminal apparatus 10d are collectively referred to as the terminal apparatus 10. The terminal apparatus 10 is a wireless terminal capable of performing business wireless communication with a further terminal apparatus 10 via the base station apparatus 12. This communication can be a phone call or data communication. An example of a phone call will be described below. Since a known technology may be used for business wireless, a detailed description thereof will be omitted.

The first terminal apparatus 10a is a vehicle-mounted terminal, and the second terminal apparatus 10b to the fourth terminal apparatus 10d are mobile terminals possessed by the user. The transmission power of the first terminal apparatus 10a is assumed to be higher than the transmission power of each of the second terminal apparatus 10b to the fourth terminal apparatus 10d. The first terminal apparatus 10a may be supplied with power from the vehicle. The number of terminal apparatuses 10 is not limited to “4”, and the number of vehicle-mounted terminals is not limited to “1”.

The base station apparatus 12 is a wireless base station and forms a communication area 100. Within the communication area 100, the terminal apparatus 10 can receive a wireless signal transmitted from the base station apparatus 12, and the base station apparatus 12 can receive a wireless signal transmitted by the terminal apparatus 10.

Outside the communication area 100, there is a donut shaped partially reception-enabled area 106. In the partially reception-enabled area 106, the first terminal apparatus 10a to the fourth terminal apparatus 10d can partially receive the wireless signal transmitted from the base station apparatus 12. That is, the wireless signal from the base station apparatus 12 is difficult to reach, and a call may be interrupted in the partially reception-enabled area 106. Further, the partially reception-enabled area 106 is an area in which the base station apparatus 12 cannot receive the wireless signal transmitted by the second terminal apparatus 10b, the third terminal apparatus 10c, and the fourth terminal apparatus 10d, which are mobile terminals. Since the first terminal apparatus 10a, which is a vehicle-mounted terminal, has a larger transmission power than the mobile terminal, the first terminal apparatus 10a can deliver a transmission signal to the base station apparatus 12 from at least a part of the partially reception-enabled area 106.

Located outside the partially reception-enabled area 106 is a dead zone, i.e., an area where communication is disabled and is an area where the terminal apparatus 10 cannot receive the signal transmitted from the base station apparatus 12, and the base station apparatus 12 cannot receive the signal transmitted by the terminal apparatus 10.

A predetermined area 102 is set within the communication area 100. Being located within the predetermined area 102 is one of the conditions that allow the terminal apparatus 10 to assume the role of forwarding. The predetermined area 102 is, for example, an outer edge area of the communication area 100 and is donut shaped. Because the predetermined area 102 is an outer edge area, it is easier to forward the signal to the terminal apparatus 10 at a position distanced from the communication area 100. The predetermined area 102 may not be limited to an outer edge area but may be an area inside the outer edge of the communication area 100. A plurality of predetermined areas 102 may be set. The position, extent, and number of the predetermined areas 102 can be appropriately determined by an experiment or simulation.

In the example of FIG. 1, the first terminal apparatus 10a and the fourth terminal apparatus 10d are located in the communication area 100. The first terminal apparatus 10a is located in the predetermined area 102 of the communication area 100. The second terminal apparatus 10b is located in the partially reception-enabled area 106, and the third terminal apparatus 10c is located in a communication-disabled area outside the partially reception-enabled area 106.

For example, an audio signal transmitted by the fourth terminal apparatus 10d is received by the first terminal apparatus 10a via the base station apparatus 12 but is received only partially by the second terminal apparatus 10b and is not received by the third terminal apparatus 10c. The base station apparatus 12 determines, from among the plurality of terminal apparatuses 10, the first terminal apparatus 10a having a transmission power larger than the threshold value and located in the predetermined area 102 to be the forwarding terminal. The first terminal apparatus 10a determined to be the forwarding terminal stores the audio signal received from the base station apparatus 12 and forwards the stored audio signal to the second terminal apparatus 10b and the third terminal apparatus 10c. The second terminal apparatus 10b and the third terminal apparatus 10c can receive the audio signal in a shorter time than when the apparatuses move to the communication area 100 without moving to the communication area 100.

Since the first terminal apparatus 10a has a relatively large transmission power and is located in the outer edge area of the communication area 100, the first terminal apparatus 10a is suitable for forwarding to the terminal apparatus 10 distanced from the communication area 100. Thus, the terminal apparatus 10 suitable for forwarding can be determined from among the plurality of movable terminal apparatuses 10 depending on the situation.

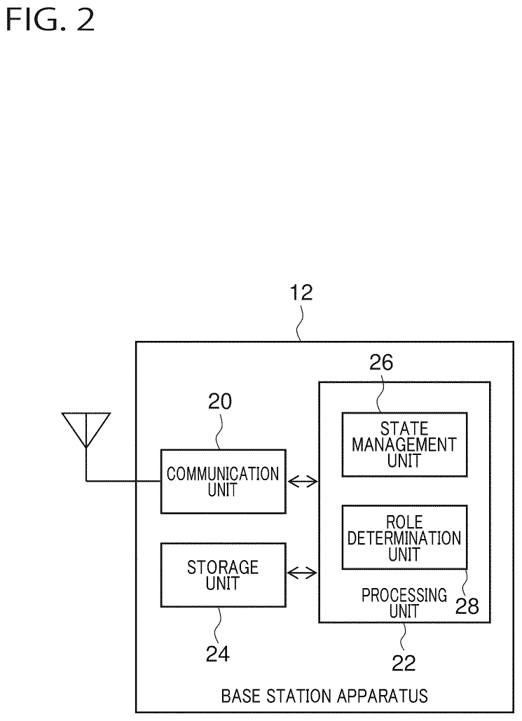

FIG. 2 shows a configuration of the base station apparatus 12 of FIG. 1. The base station apparatus 12 includes a communication unit 20, a processing unit 22, and a storage unit 24. The processing unit 22 includes a state management unit 26 and a role determination unit 28.

The communication unit 20 communicates wirelessly with each of the plurality of terminal apparatuses 10. The storage unit 24 stores a terminal state table including the state of each of the plurality of terminal apparatuses 10. The state management unit 26 manages the state of each of the plurality of terminal apparatuses 10 using the terminal state table. The role determination unit 28 determines the role of at least one terminal apparatus 10 based on terminal information transmitted from the terminal apparatus 10. Details of the function of each part will be described later.

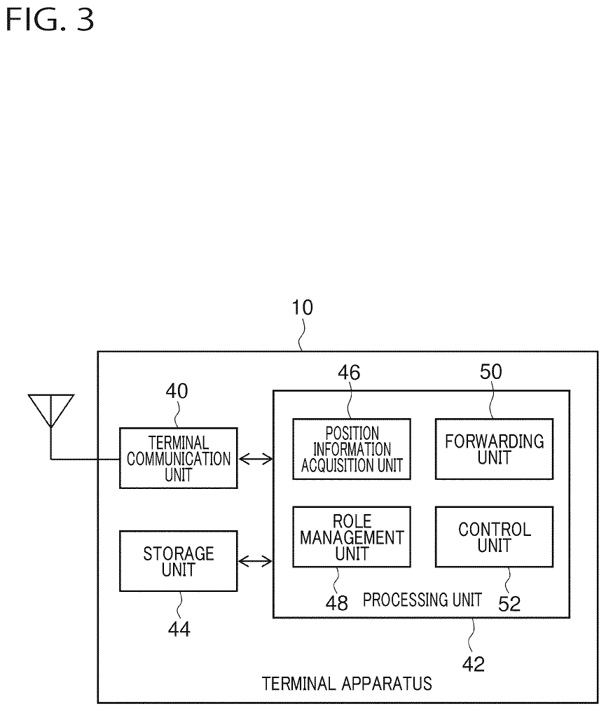

FIG. 3 shows a configuration of the terminal apparatus 10 of FIG. 1. The terminal apparatus 10 includes a terminal communication unit 40, a processing unit 42, and a storage unit 44. The processing unit 42 includes a position information acquisition unit 46, a role management unit 48, a forwarding unit 50, and a control unit 52. The configuration is common to the first terminal apparatus 10a to the fourth terminal apparatus 10d shown in FIG. 1. As described above, however, the transmission power of the first terminal apparatus 10a mounted on a vehicle is higher than the transmission power of the other terminal apparatuses 10.

The terminal communication unit 40 communicates wirelessly with the base station apparatus 12 and a further terminal apparatus 10. The position information acquisition unit 46 has a GPS (Global Positioning System) positioning function, periodically measures the position of the host terminal apparatus 10, and periodically acquires position information resulting from the measurement. The position information is indicated by latitude and longitude. The time of acquisition is attached to the position information. The position information acquisition unit 46 stores the acquired position information in the storage unit 44.

The storage unit 44 stores terminal information on the host terminal apparatus 10, the terminal information including the position information, information on the role of the host terminal apparatus 10, and information on a preset transmission power. In the case where the role of the host terminal apparatus 10 is a forwarding role, the storage unit 44 also stores a forwarding destination state table including the state of the terminal apparatus 10 at the forwarding destination. It should be noted that the forwarding role is the name of a role assumed by the terminal apparatus 10 to forward the signal from the base station.

The role management unit 48 manages the role of the host terminal apparatus 10. In the case where the role of the host terminal apparatus 10 is the forwarding role, the forwarding unit 50 causes the terminal communication unit 40 to forward the audio signal received from the base station apparatus 12 to a further terminal apparatus 10. The control unit 52 controls the operation of the host terminal apparatus 10 according to the role of the host terminal apparatus 10. Details of the function of each part will be described later.

The features of the terminal apparatus 10 and the base station apparatus 12 are implemented in hardware such as a CPU of a computer, a memory, or other LSI's, and in software such as a program loaded into a memory, etc. The figure depicts functional blocks implemented by the cooperation of these elements. Therefore, it will be obvious to those skilled in the art that the functional blocks may be implemented in a variety of manners by hardware only, by software only, or by a combination of hardware and software.

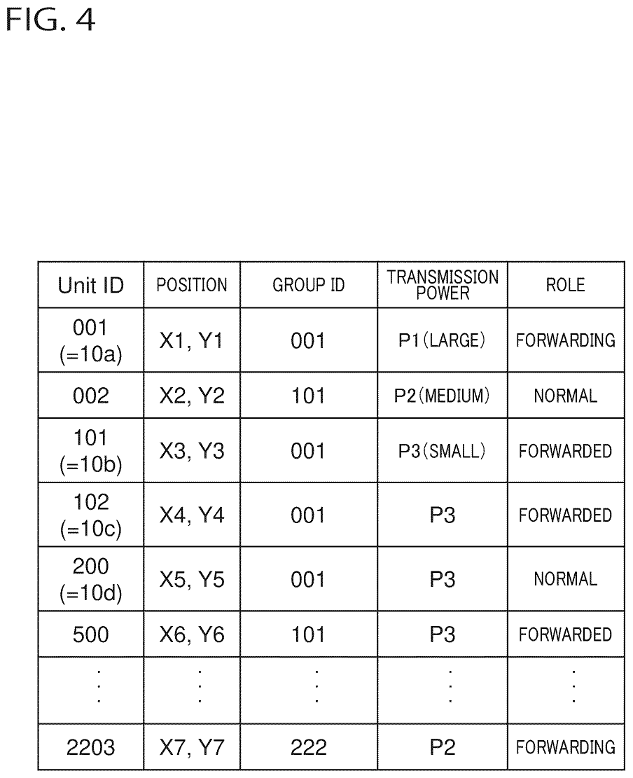

FIG. 4 shows a data structure of a terminal state table maintained in the storage unit 24 of the base station apparatus 12 of FIG. 2. The terminal state table includes information including the position, group ID, transmission power, and role (Unit role) on each Unit ID, which is identification information on the terminal apparatus 10 with which the base station apparatus 12 can communicate.

For example, Unit ID=001 corresponds to the first terminal apparatus 10a, Unit ID=101 corresponds to the second terminal apparatus 10b, Unit ID=102 corresponds to the third terminal apparatus 10c, and Unit ID=200 corresponds to the fourth terminal apparatus 10d.

The group ID is identification information on the group to which the terminal apparatus 10 belongs. The group ID of the first terminal apparatus 10a to the fourth terminal apparatus 10d is “001”, showing that the first terminal apparatus 10a to the fourth terminal apparatus 10d belong to the same group. The base station apparatus 12 executes communication for each group.

A further group may be formed by a plurality of terminal apparatuses 10 not shown in FIG. 1. In the illustrated terminal state table, information on a plurality of terminal apparatuses 10 in a group other than the group of the first terminal apparatus 10a is also shown.

The transmission power is indicated by P1, P2, or P3. For example, P1 and P2 are larger than a preset threshold value, P1 is larger than P2, and P3 is equal to or smaller than the threshold value. The transmission power may be organized into two classes or four or more classes.

The transmission power may be replaced by a transmission range (RF Range) representing a range reached by transmitted radio waves. In the case of a transmission range, the range is indicated to be, for example, large, medium, or small. When the transmission range is large or medium, it represents that the transmit power is larger than the threshold value. When the transmission range is small, it represents that the transmission power is equal to or smaller the threshold value. The transmission range represents information about the transmission power. The transmission power or transmission range may be organized into two classes or four or more classes.

The role is indicated by “normal”, “forwarding”, or “forwarded. These are also called normal role, forwarding role, and forwarded role. That the fourth terminal apparatus 10d is “normal” represents that it can transmit and receive the signal directly to and from the base station apparatus 12, does not forward the signal to a further terminal apparatus 10, and does not receive the signal forwarded from a further terminal apparatus 10. That the first terminal apparatus 10a is “forwarding” represents that it is a source of forwarding that forwards the signal to a further terminal apparatus 10. That the second terminal apparatus 10b and the third terminal apparatus 10c are “forwarded” represents that the signal is forwarded thereto from the terminal apparatus 10 having the forwarding role. The entry “forwarded” may include information on a partial forwarded signal reception role or a full forwarded signal reception role described later.

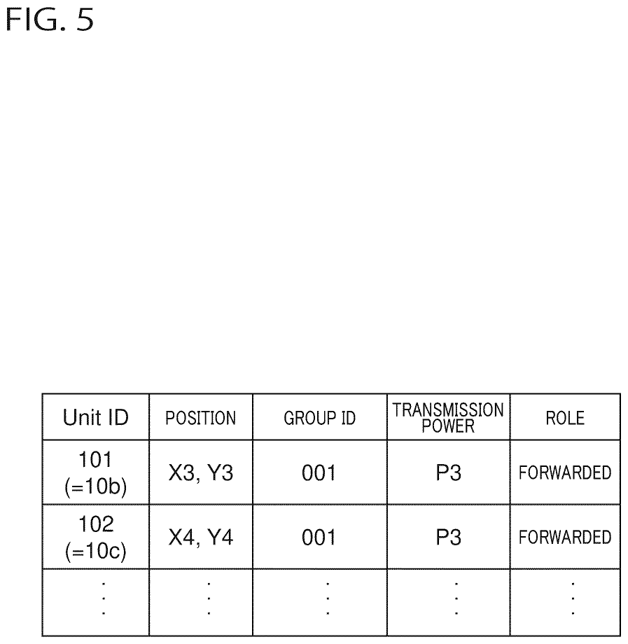

FIG. 5 shows a data structure of a forwarding destination state table maintained in the storage unit 44 of the first terminal apparatus 10a of FIG. 1 having the forwarding role. The destination status table includes information including the position, group ID, transmission power, and role for each unit ID. Unit ID is identification information on the terminal apparatus 10 at the forwarding destination. In the illustrated example, identification information on the second terminal apparatus 10b and the third terminal apparatus 10c is maintained as Unit ID.

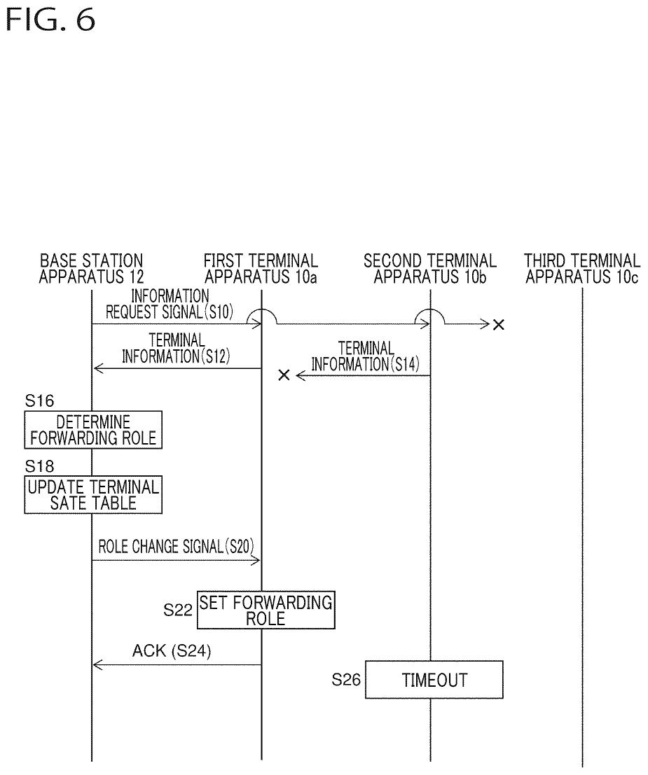

The operation of the communication system 1 according to the above configuration will be described in detail. FIG. 6 is a sequence chart showing a sequence of steps for communication in the communication system 1 of FIG. 1. FIG. 6 mainly shows a process to determine the forwarding role.

The base station apparatus 12 transmits an information request signal requesting terminal information to the plurality of terminal apparatuses 10 (S10). Specifically, the state management unit 26 causes the communication unit 20 to transmit the information request signal to the plurality of terminal apparatuses 10. The first terminal apparatus 10a and the second terminal apparatus 10b each receives the information request signal, but the third terminal apparatus 10c does not receive the information request signal.

The first terminal apparatus 10a transmits the terminal information on the terminal apparatus 10 to the base station apparatus 12 (S12). The second terminal apparatus 10b transmits the terminal information on the terminal apparatus 10 to the base station apparatus 12 (S14). Specifically, the role management unit 48 in the terminal apparatus 10 reads the terminal information stored in the storage unit 44 and causes the terminal communication unit 40 to transmit the terminal information thus read to the base station apparatus 12, when the terminal communication unit 40 receives the information request signal from the base station apparatus 12.

Since the terminal apparatus 10 transmits, as the terminal information, information related to the transmission power and position information on the terminal apparatus 10 to the base station apparatus 12, the terminal apparatus 10 can cause the base station apparatus 12 to determine the terminal apparatus 10 that executes forwarding from among the plurality of terminal apparatuses 10 depending on the situation.

The base station apparatus 12 receives the terminal information transmitted from the first terminal apparatus 10a in S12. Specifically, the state management unit 26 causes the communication unit 20 to receive the terminal information transmitted from the terminal apparatus 10 in response to the information request signal, the terminal information including the information on the transmission power, position information, and role of the terminal apparatus 10. The terminal information transmitted from the second terminal apparatus 10b in S14 does not reach the base station apparatus 12.

When the received terminal information satisfies a predetermined condition, the base station apparatus 12 determines the role of the first terminal apparatus 10a originating the terminal information to be the forwarding role for forwarding the audio signal (S16). Specifically, the role determination unit 28 identifies, from among the plurality of terminal apparatuses 10, the terminal apparatus 10 having a transmission power larger than a preset threshold value and located in the predetermined area 102 within the preset communication area 100 of the host base station apparatus 12, based on the received terminal information, and determines the role of the terminal apparatus 10 thus identified to be forwarding role.

The base station apparatus 12 updates the terminal state table in the storage unit 24 (S18). The base station apparatus 12 transmits a role change signal to the first terminal apparatus 10a (S20). Specifically, the role determination unit 28 causes the communication unit 20 to transmit the role change signal notifying the terminal apparatus 10, whose role is determined to be the forwarding role, that the forwarding role is assigned thereto.

The first terminal apparatus 10a sets the role of the terminal apparatus 10 to be the forwarding role in response to the reception of the role change signal (S22). Specifically, the role management unit 48 sets the role of the host terminal apparatus 10 to be the forwarding role when the terminal communication unit 40 receives the role change signal transmitted when the base station apparatus 12 determines that the terminal information satisfies the predetermined condition. The first terminal apparatus 10a transmits an ACK signal indicating that the role change signal has been received to the base station apparatus 12 (S24).

The second terminal apparatus 10b times out because it does not receive a role change signal for a certain period of time after transmitting the terminal information in S14 (S26).

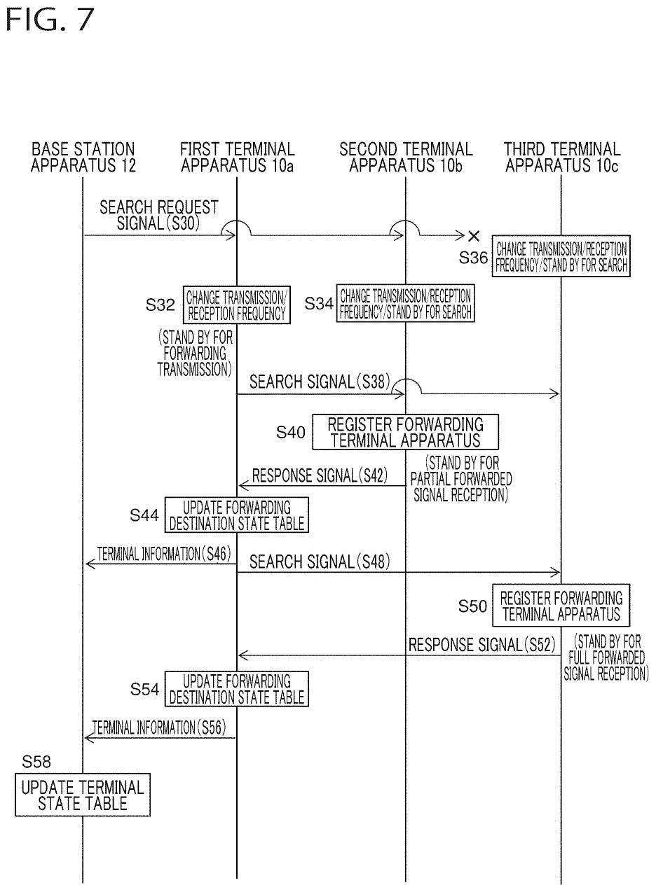

FIG. 7 is a sequence chart showing a sequence of steps, following FIG. 6, for communication in the communication system 1. FIG. 7 shows a process mainly related to search.

After S24 in FIG. 6, the base station apparatus 12 transmits a search request signal to the plurality of terminal apparatuses 10 (S30). Specifically, the state management unit 26 causes the communication unit 20 to transmit the search request signal to the plurality of terminal apparatuses 10.

The first terminal apparatus 10a changes the transmission/reception frequency to a frequency for forwarding that enables communication with a further terminal apparatus 10 when the first terminal apparatus 10a receives the search request signal (S32).

Since the second terminal apparatus 10b does not have the forwarding role, the second terminal apparatus 10b changes, when it receives the search request signal, the transmission/reception frequency to the frequency for forwarding that enables communication with the terminal apparatus 10 having the forwarding role and stands by for a search (S34).

The third terminal apparatus 10c does not receive the information request signal for a predetermined period of time and so changes the transmission/reception frequency to the frequency for forwarding and stands by for a search (S36).

After S32, the first terminal apparatus 10a transmits a search signal to the second terminal apparatus 10b and the third terminal apparatus 10c (S38). Specifically, in the case where the role of the host terminal apparatus 10 is the forwarding role, the control unit 52 causes the terminal communication unit 40 to transmit the search signal to a further terminal apparatus 10 when the terminal communication unit 40 receives the search request signal from the base station apparatus 12.

Upon receiving the search signal, the second terminal apparatus 10b registers the first terminal apparatus 10a, the forwarding terminal apparatus 10 (S40), and transmits a response signal including the terminal information on the terminal apparatus 10 to the forwarding source terminal apparatus 10 (S42).

Upon receiving the response signal from the second terminal apparatus 10b, the first terminal apparatus 10a updates the forwarding destination state table (S44) and transmits the terminal information on the second terminal apparatus 10b to the base station apparatus 12 (S46). Specifically, in the case where the role of the host terminal apparatus 10 is the forwarding role, the control unit 52 causes the terminal communication unit 40 to transmit the terminal information on the further terminal apparatus 10 included in the response signal to the base station apparatus 12. In this way, the base station apparatus 12 can be notified of the terminal information on the further terminal apparatus 10 located around the terminal apparatus 10 having the forwarding role.

After S46, the first terminal apparatus 10a transmits the search signal to the third terminal apparatus 10c (S48). Upon receiving the search signal, the third terminal apparatus 10c registers the forwarding terminal apparatus 10 (S50) and transmits a response signal including the terminal information on the terminal apparatus 10 to the forwarding terminal apparatus 10 (S52).

Upon receiving the response signal from the third terminal apparatus 10c, the first terminal apparatus 10a updates the forwarding destination state table (S54) and transmits the terminal information on the third terminal apparatus 10c to the base station apparatus 12 (S56).

The base station apparatus 12 receives the terminal information on the second terminal apparatus 10b and the third terminal apparatus 10c from the first terminal apparatus 10a and updates the terminal state table based on the received terminal information (S58). Specifically, the state management unit 26 causes the communication unit 20 to receive the terminal information on the further terminal apparatus 10 acquired by the terminal apparatus 10 having the forwarding role and transmitted from the terminal apparatus 10 having the forwarding role in response to the search request signal. The state management unit 26 updates the terminal state table. This allows the base station apparatus 12 to acquire the terminal information on the terminal apparatus 10 not having the forwarding role as well.

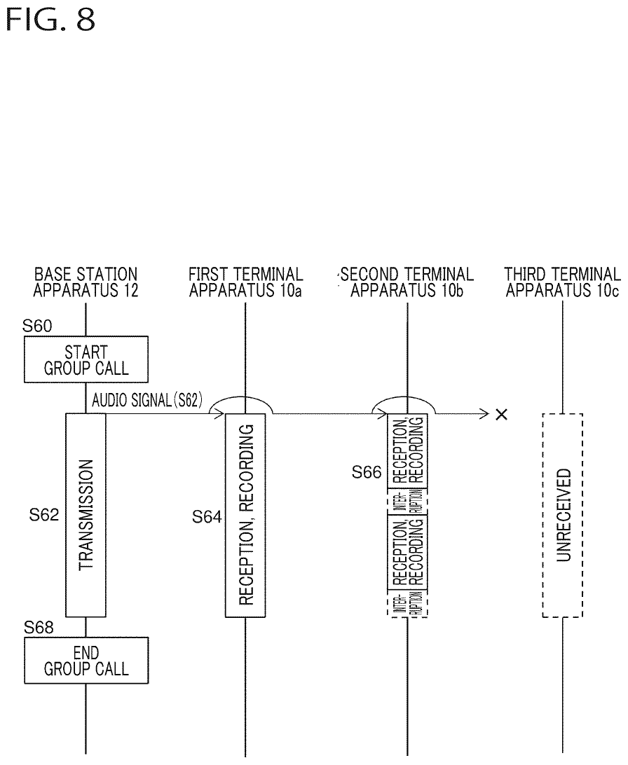

FIG. 8 is a sequence chart showing a sequence of steps, following FIG. 7, for communication in the communication system 1. FIG. 8 shows a process for transmission/reception of the audio signal.

The base station apparatus 12 starts a group call (S60) and transmits the audio signal received from the fourth terminal apparatus 10d (not shown in FIG. 8) from the first terminal apparatus 10a to the third terminal apparatus 10c (S62).

The first terminal apparatus 10a receives the audio signal from the base station apparatus 12 and records the audio (S64). Specifically, the forwarding unit 50 stores the audio signal received by the terminal communication unit 40 in the storage unit 44. Further, the first terminal apparatus 10a reproduces audio from the received audio signal and outputs the audio from an audio output apparatus such as a speaker.

The second terminal apparatus 10b receives a part of the audio signal from the base station apparatus 12 and records the audio (S66). Further, the second terminal apparatus 10b reproduces audio from the received audio signal. Due to poor reception, however, the reception of the audio signal is interrupted.

The third terminal apparatus 10c cannot receive the audio signal from the base station apparatus 12. The base station apparatus 12 ends the group call (S68) when the transmission of the audio signal is completed.

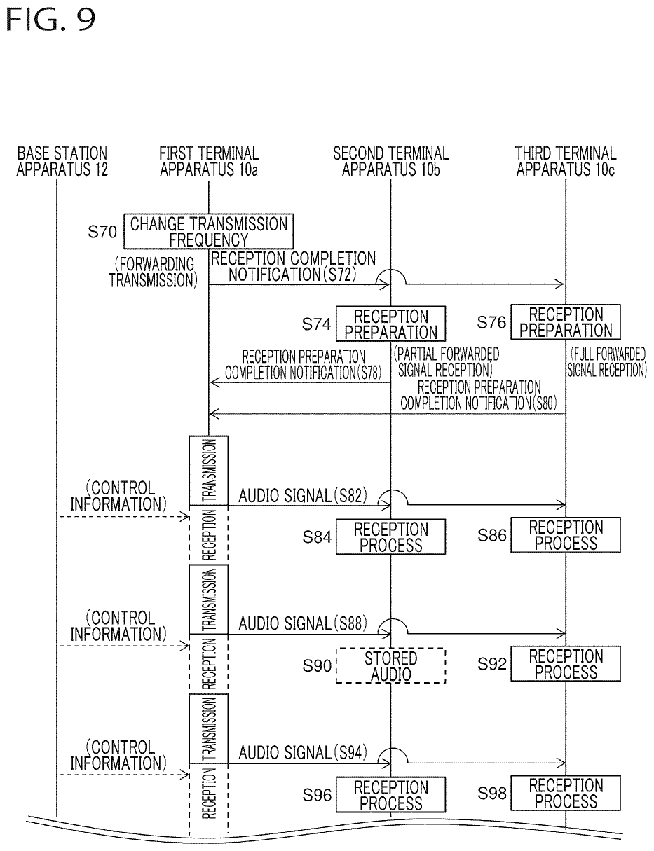

FIG. 9 is a sequence chart showing a sequence of steps, following FIG. 8, for communication in the communication system 1. FIG. 9 shows a forwarding process.

The first terminal apparatus 10a changes the transmission frequency to the transmission frequency of the base station apparatus 12 (S70) and transmits a reception completion notification to the second terminal apparatus 10b and the third terminal apparatus 10c (S72).

Upon receiving the reception completion notification, the second terminal apparatus 10b prepares for reception (S74) and transmits a reception preparation completion notification to the first terminal apparatus 10a when the preparation is completed (S78). Preparation for reception includes changing the transmission/reception frequency to the frequency for forwarding.

The third terminal apparatus 10c also prepares for reception upon receiving the reception completion notification (S76) and transmits a reception preparation completion notification to the first terminal apparatus 10a when the preparation is completed (S80).

Upon receiving the reception preparation completion notification after changing the transmission/reception frequency to the frequency for forwarding, the first terminal apparatus 10a transmits the audio signal to the second terminal apparatus 10b and the third terminal apparatus 10c (S82). That is, the first terminal apparatus 10a forwards the audio signal. Since the first terminal apparatus 10a divides the stored audio signal and sequentially transmits the signal in bursts, the audio signal transmitted in this case is a part of the stored audio signal.

The second terminal apparatus 10b performs a process to receive the audio signal (S84). The third terminal apparatus 10c also performs a process to receive the audio signal (S86). The reception process includes storing the audio signal.

The first terminal apparatus 10a executes a reception process after S82 and receives control information when it is transmitted from the base station apparatus 12. The control information is transmitted when, for example, a new group call is started and includes an instruction to interrupt the transmission of the audio signal. In the illustrated example, it is assumed that the control information is not transmitted.

After the reception process, the first terminal apparatus 10a transmits the next audio signal to the second terminal apparatus 10b and the third terminal apparatus 10c (S88). The second terminal apparatus 10b determines that the transmitted audio signal is the same as the audio signal stored in S66 (S90) and does not execute the reception process. The third terminal apparatus 10c performs a process to receive the audio signal (S92).

The first terminal apparatus 10a performs the reception process after S88 and then transmits the audio signal to the second terminal apparatus 10b and the third terminal apparatus 10c (S94). The second terminal apparatus 10b performs the process to receive the audio signal (S96). The third terminal apparatus 10c performs the process to receive the audio signal (S98). Thereafter, these processes are repeated.

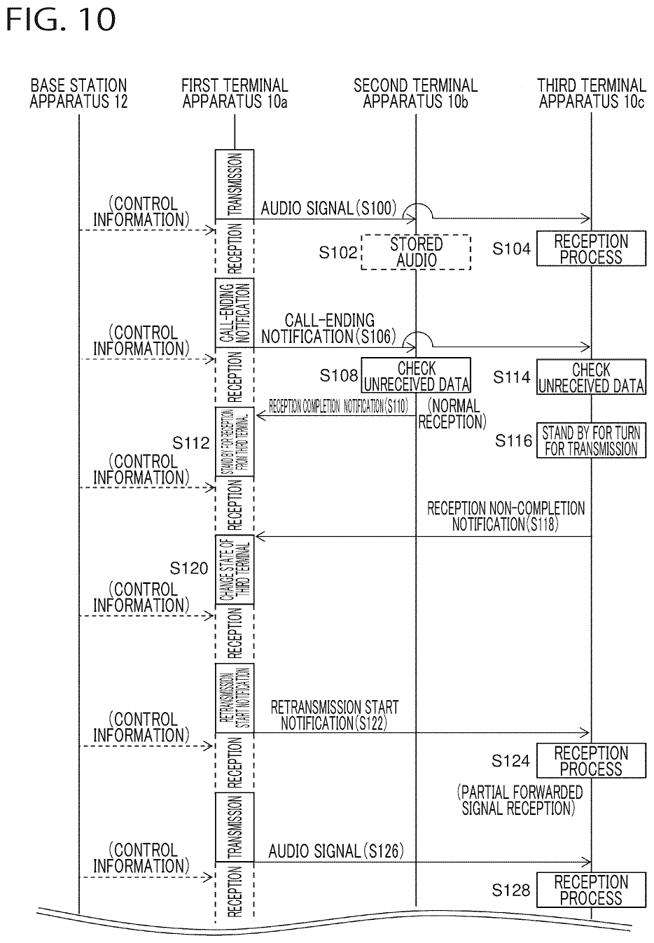

FIG. 10 is a sequence chart showing a sequence of steps, following FIG. 9, for communication in the communication system 1. FIG. 10 also shows the forwarding process.

The first terminal apparatus 10a transmits the audio signal to the second terminal apparatus 10b and the third terminal apparatus 10c (S100). It is assumed that the entire audio signal stored has been transmitted with this.

The second terminal apparatus 10b determines that the audio signal transmitted is the same as the audio signal stored in S66 (S102). The third terminal apparatus 10c performs the process to receive the audio signal (S104).

The first terminal apparatus 10a performs the reception process after S100 and then transmits a call-ending notification to the second terminal apparatus 10b and the third terminal apparatus 10c (S106).

Upon receiving the call-ending notification, the second terminal apparatus 10b performs a process to check unreceived data (S108), and the second terminal apparatus 10b transmits a reception completion notification to the first terminal apparatus 10a when there is no unreceived data, (S110). The second terminal apparatus 10b reproduces the stored audio signal.

Upon receiving the reception completion notification from the second terminal apparatus 10b, the first terminal apparatus 10a stands by for reception from the third terminal apparatus 10c (S112).

Upon receiving the call-ending notification, the third terminal apparatus 10c performs a process to check unreceived data (S114), stands by for the turn for transmission (S116), and transmits a reception non-completion notification to the first terminal apparatus 10a when there is unreceived data (S118).

Upon receiving the reception non-completion notification from the third terminal apparatus 10c, the first terminal apparatus 10a changes the state of the third terminal apparatus 10c in the forwarding destination state table (S120).

The first terminal apparatus 10a transmits a retransmission start notification to the third terminal apparatus 10c originating the reception non-completion notification (S122). Upon receiving the retransmission start notification, the third terminal apparatus 10c performs the reception process (S124) and sets the role of the terminal apparatus 10 to be the partial forwarded signal reception role.

The first terminal apparatus 10a transmits the audio signal to the third terminal apparatus 10c (S126). The first terminal apparatus 10a divides and retransmits the stored audio signal. The third terminal apparatus 10c performs the process to receive the audio signal (S128). Thereafter, these processes are repeated.

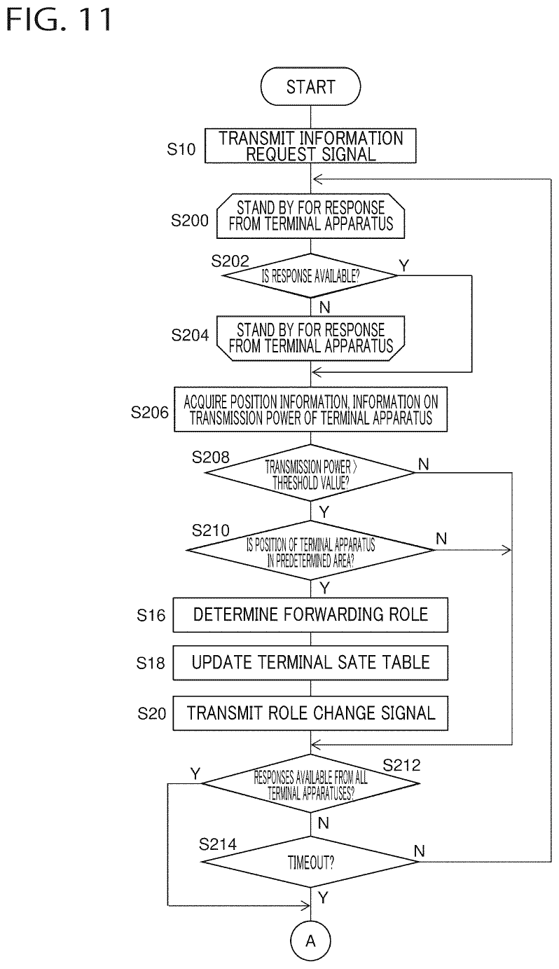

FIG. 11 is a flowchart showing the process in the base station apparatus 12 of FIG. 1. The process of FIG. 11 corresponds to the process of the sequence chart of FIG. 6.

The communication unit 20 transmits the information request signal to the plurality of terminal apparatuses 10 (S10) and starts a loop process to stand by for a response from the terminal apparatus 10 (S200). In the absence of a response of the terminal information from the terminal apparatus 10 (N in S202), control returns to S200 in the loop process (S204). In the presence of a response of the terminal information from the terminal apparatus 10 (Y in S202), the role determination unit 28 acquires the position information and information on a transmission power on the terminal apparatus 10 included in the terminal information (S206).

The role determination unit 28 determines the role of the terminal apparatus 10 transmitting the terminal information to be the forwarding role (S16) when the transmission power is larger than the threshold value (Y in S208) and the position of the terminal apparatus 10 is in the predetermined area 102 (Y in S210).

The state management unit 26 updates the terminal state table (S18), and the communication unit 20 transmits the role change signal to the terminal apparatus 10 whose role is determined to be the forwarding role (S20).

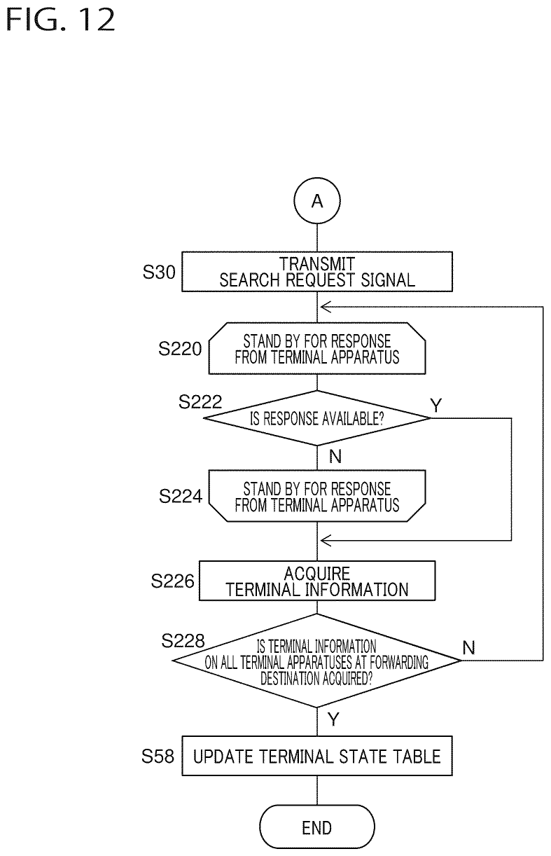

When responses are available from all terminals 10 (Y in S212), control shifts to “A” in FIG. 12. When responses from all terminal apparatuses 10 are not available (N in S212) and a timeout occurs after an elapse of a predetermined period of time (Y in S214), control shifts to “A” in FIG. 12. When a timeout does not occur in S214 (N in S214), control returns to S200.

When the transmission power is equal to or smaller than the threshold value in S208 (N in S208), control shifts to S212. When the position of the terminal apparatus 10 is not in the predetermined area 102 in S210 (N in S210), control shifts to S212.

FIG. 12 is a flowchart showing the process, following FIG. 11, in the base station apparatus 12. The process of FIG. 12 corresponds to the process of the sequence chart of FIG. 7.

In continuation from “A” in FIG. 11, the communication unit 20 transmits the search request signal to the plurality of terminal apparatuses 10 (S30) and starts a loop process to stand by for a response from the terminal apparatus 10 (S220). In the absence of a response of the terminal information from the terminal apparatus 10 (N in S222), control returns to S220 in the loop process (S224). In the presence of a response of the terminal information from the terminal apparatus 10 (Y in S222), the state management unit 26 acquires the terminal information (S226).

When the terminal information on all terminal apparatuses 10 at the forwarding destination is not acquired (N in S228), control returns to S220. When the terminal information on all terminal apparatuses 10 at the forwarding destination is acquired (Y in S228), the state management unit 26 updates the terminal state table (S58) and terminates the process.

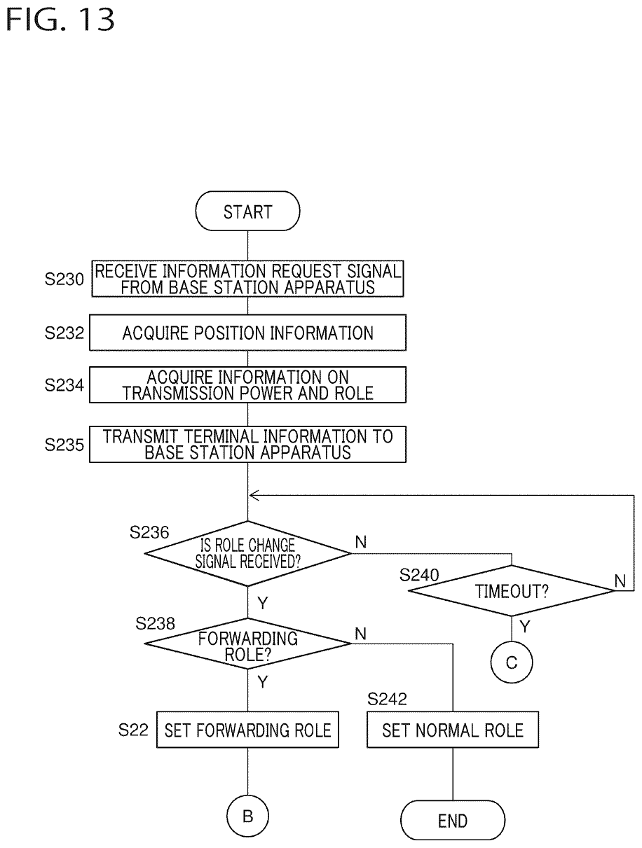

FIG. 13 is a flowchart showing the process in the terminal apparatus 10 of FIG. 1. The process of FIG. 13 corresponds to the process in each of the first terminal apparatus 10a and the second terminal apparatus 10b of the sequence chart of FIG. 6.

The terminal communication unit 40 receives the information request signal from the base station apparatus 12 (S230), the position information acquisition unit 46 acquires the position information on the host terminal apparatus 10 (S232), and the role management unit 48 acquires the information on a transmission power and the role from the storage unit 44 (S234). The terminal communication unit 40 transmits the terminal information to the base station apparatus 12 (S235). The process of S235 corresponds to the process of S12 or S14 of FIG. 6.

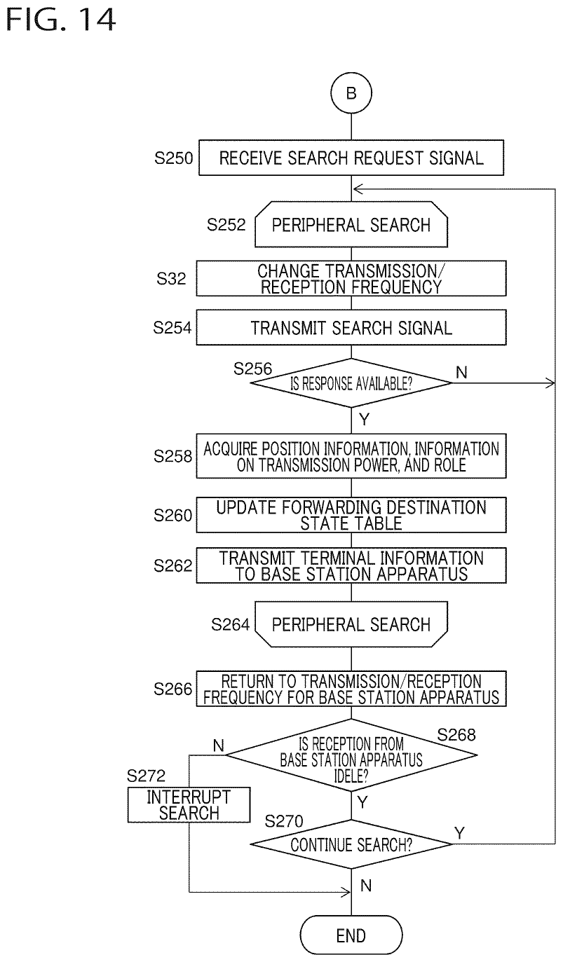

The role management unit 48 sets the role of the host terminal apparatus 10 to be the forwarding role (S22) provided that the terminal communication unit 40 receives the role change signal (Y in S236) and the host terminal has the forwarding role (Y in S238), and control shifts to “B” in FIG. 14. This process is the process in the first terminal apparatus 10a.

The role management unit 48 sets the role of the host terminal apparatus 10 to be the normal role (S242) when it is determined in S238 that the role is not the forwarding role (N in S238), whereupon the process is terminated.

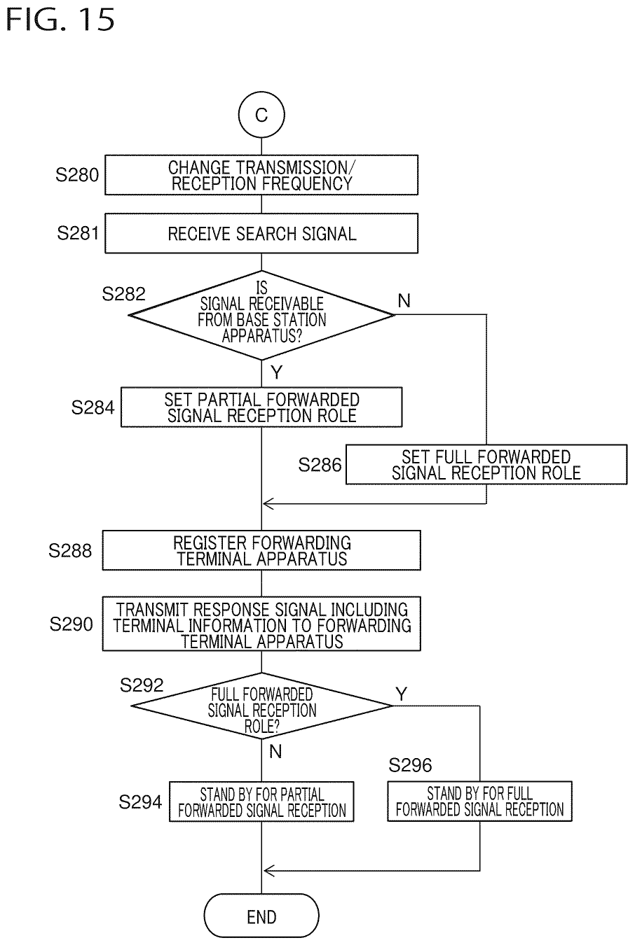

In the case the role change signal is not received in S236 (N in S236), control shifts to “C” in FIG. 15 when a timeout occurs after an elapse of a predetermined period of time (Y in S240). This process is the process in the second terminal apparatus 10b. When a timeout does not occur (N in S240), control returns to S236.

FIG. 14 is a flowchart showing the process, following FIG. 13, in the terminal apparatus 10. The process of FIG. 14 shows the process in the first terminal apparatus 10a in the sequence chart of FIG. 7, i.e., the process in the terminal apparatus 10 having the forwarding roll.

In continuation from “B” in FIG. 13, the terminal communication unit 40 receives the search request signal from the base station apparatus 12 (S250). The terminal apparatus 10 starts the loop process for peripheral search (S252). The terminal communication unit 40 changes the transmission/reception frequency to the frequency for forwarding (S32). When the frequency has already been changed to the frequency for forwarding, that frequency is maintained. The terminal communication unit 40 transmits the search signal to the further terminal apparatus 10 (S254). The process of S254 corresponds to the process of S38 or S48 of FIG. 7.

In the absence of a response from the further terminal apparatus 10 (N in S256), control returns to S252. In the presence of a response from the further terminal apparatus 10 (Y in S256), the control unit 52 acquires the position information, information on a transmission power, and role included in the response signal (S258) and updates the forwarding destination state table (S260). The terminal communication unit 40 transmits the terminal information to the base station apparatus 12 (S262). The process of S260 corresponds to the process of S44 or S54 of FIG. 7. The process of S262 corresponds to the process of S46 or S56 of FIG. 7. When the responses from all other terminals 10 have not been processed, control returns to S252 in the loop process (S264).

When the responses from all other terminal apparatuses 10 have been processed, the loop process is exited, and the terminal communication unit 40 returns to the transmission/reception frequency for the base station apparatus 12 (S266). Control returns to S252 when the reception from the base station apparatus 12 is idle (Y in S268) and the search is continued (Y in S270). The process is terminated when the search is not continued (N in S270). The control unit 52 interrupts the search (S272) and terminates the process when the reception from the base station apparatus 12 is not idle in S268 (N in S268).

FIG. 15 is a flowchart showing the process, following FIG. 13, in the terminal apparatus 10. The process of FIG. 15 shows the process in each of the second terminal apparatus 10b and the third terminal apparatus 10c of the sequence chart of FIG. 7, i.e., the process in the terminal apparatus 10 at the forwarding destination. FIG. 15 presents a process following “C” in FIG. 13, but the third terminal apparatus 10c that does not receive the information request signal for a predetermined period of time also starts the process of FIG. 15.

The terminal communication unit 40 changes the transmission/reception frequency (S280) and receives the search signal from the first terminal apparatus 10a at the forwarding source (S281). The process of S280 corresponds to the process of S34 or S36 of FIG. 7. The process of S281 corresponds to the process of S38 or S48 of FIG. 7.

The role management unit 48 sets the role of the host terminal apparatus 10 to be the partial forwarded signal reception role that receives a part of the audio signal forwarded from the further terminal apparatus 10 having the forwarding role (S284) provided that it is possible to receive the signal from the base station apparatus 12 (Y in S282), That is, the role management unit 48 sets the role of the host terminal apparatus 10 to be the partial forwarded signal reception role when the role change signal is not received after the terminal communication unit 40 transmits the terminal information.

The role management unit 48 sets the role of the host terminal apparatus 10 to be the full forwarded signal reception role that receives the entire audio signal forwarded from the further terminal apparatus 10 having the forwarding role (S286) provided that it is not possible to receive the signal from the base station apparatus 12 (N in S282). That is, the role management unit 48 sets the role of the host terminal apparatus 10 to be the full forwarded signal reception role when the terminal communication unit 40 receives the search signal from the further terminal apparatus 10 having the forwarding role without receiving the information request signal. This allows setting the role of the host terminal apparatus 10 depending on the status of reception of the signal from the base station apparatus 12.

The control unit 52 registers the forwarding terminal apparatus 10 in the storage unit 44 (S288), and the terminal communication unit 40 transmits the response signal including the terminal information to the forwarding terminal apparatus 10 (S290). Specifically, the control unit 52 causes, when the role of the host terminal apparatus 10 is the partial forwarded signal reception role or the full forwarded signal reception role, the terminal communication unit 40 to transmit the response signal to the further terminal apparatus 10 having the forwarding role in response to the search signal, the response signal including the information on the role of the host terminal apparatus 10. The process of S288 corresponds to the process of S40 or S50 of FIG. 7. The process of S290 corresponds to the process of S42 or S52 of FIG. 7.

When the full forwarded signal reception role is not set (N in S292), the control unit 52 stands by for partial forwarded signal reception (S294) and terminates the process. When the full forwarded signal reception role is set (Y in S292), the control unit 52 stands by for full forwarded signal reception (S296) and terminates the process.

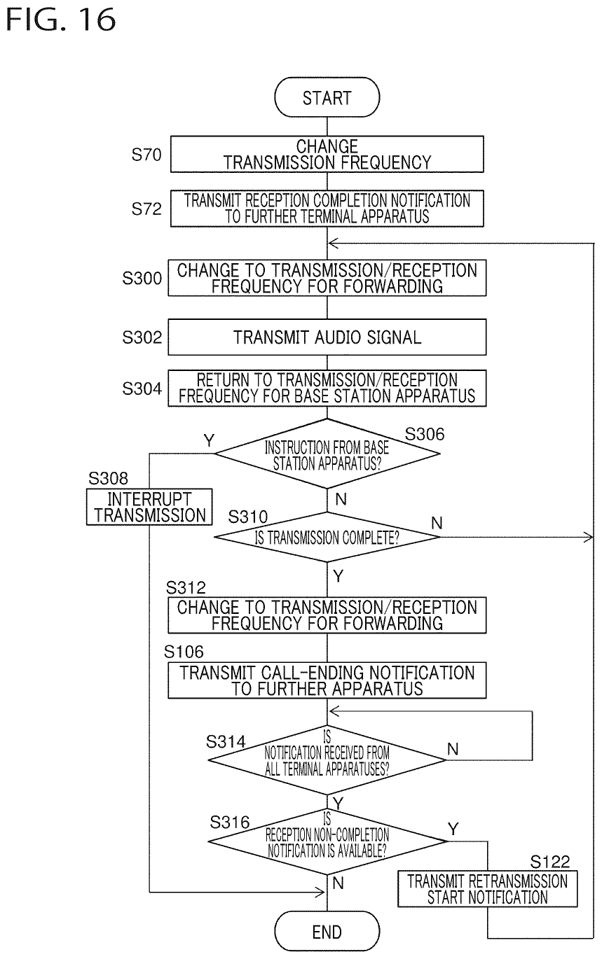

FIG. 16 is a flowchart showing a forwarding process in the terminal apparatus 10 having the forwarding role. The process of FIG. 16 shows the process in the first terminal apparatus 10a of the sequence chart of FIGS. 9 and 10.

The terminal communication unit 40 changes the transmission frequency to the transmission frequency for the base station apparatus 12 (S70) and transmits a reception completion notification to the further terminal apparatus 10 (S72).

The terminal communication unit 40 changes to the transmission/reception frequency for forwarding (S300), transmits the audio signal to the terminal apparatus 10 at the forwarding destination (S302) and returns to the transmission/reception frequency for the base station apparatus 12 (S304). The process of S302 corresponds to the process of S82, S88, and S94 of FIG. 9 and S100 and S126 of FIG. 10.

When there is an instruction from the base station apparatus 12 (Y in S306), the control unit 52 interrupts the transmission (S308) and terminates the process. When there is no instruction from the base station apparatus 12 (N in S306) and the transmission is not completed (N in S310), on the other hand, control returns to S300. When the transmission is completed (Y in S310), the terminal communication unit 40 changes to the transmission/reception frequency for forwarding (S312) and transmits a call-ending notification to the further terminal apparatus 10 (S106).

When a notification in response to the call-ending notification is not received from all terminal apparatuses 10 (N in S314), control returns to S314. When a notification in response to the call-ending notification is received from all terminal apparatuses 10 (Y in S314) and the reception non-completion notification is identified (Y in S316), the terminal communication unit 40 transmits a retransmission start notification (S122), whereupon control returns to S300. The process is terminated in the absence of the reception non-completion notification (N in S316).

### Variation of the First Embodiment

An additional condition to determine the terminal apparatus 10 of the forwarding role may be that the terminal apparatus 10 that is likely located outside the communication area 100 is nearby. Hereinafter, the difference from the first embodiment will be described.

The state management unit 26 in the base station apparatus 12 identifies, from among the plurality of terminal apparatuses 10, the particular terminal apparatus 10 likely located outside the communication area 100, based on the past position information on the terminal apparatus 10 from which the terminal information in response to the information request signal is not received. In the example of FIG. 1, the base station apparatus 12 does not receive the terminal information from each of the second terminal apparatus 10b and the third terminal apparatus 10c after transmitting the information request signal. Therefore, the positions of the second terminal apparatus 10b and the third terminal apparatus 10c included in the terminal state table are positions included in the terminal information received last time.

In the example of FIG. 1, the position of the second terminal apparatus 10b included in the terminal state table is assumed to indicate a position just before the second terminal apparatus 10b exits the communication area 100 toward the partially reception-enabled area 106. The same applies to the position of the third terminal apparatus 10c. When the past position of the terminal apparatus 10 from which the terminal information in response to the information request signal is not received is near the outer periphery of the communication area 100, the state management unit 26 identifies that terminal apparatus 10 as the particular terminal apparatus 10.

It will be noted that the terminal information received last time by the base station apparatus 12 may be the terminal information on the second terminal apparatus 10b, etc. transmitted from the first terminal apparatus 10a having the forwarding role in response to the search request signal. In this case, the position of the second terminal apparatus 10b included in the terminal state table indicates an area outside the communication area 100. When the past position of the terminal apparatus 10 from which the terminal information in response to the information request signal is not received is outside the communication area 100, the state management unit 26 equally identifies that terminal apparatus 10 as the particular terminal apparatus 10.

The state management unit 26 estimates, for example, an area where the particular terminal apparatus 10 is likely located, based on, for example, the last position of the particular terminal apparatus 10 included in the terminal state table, the time since acquisition of the position until the current time, and a preset average movement speed of the particular terminal apparatus 10.

The role determination unit 28 determines the role of the terminal apparatus 10, of the plurality of terminal apparatuses 10, having a transmission power larger than the threshold value, located in the predetermined area 102, and likely located near the particular terminal apparatus 10 to be the forwarding role.

When the range reached by radio waves transmitted by the terminal apparatus 10 at least partially overlaps the area where the estimated particular terminal apparatus may currently be located, the role determination unit 28 may identify that the terminal apparatus 10 is likely located near the particular terminal apparatus 10.

According to this variation, the role of the terminal apparatus 10 possibly near the particular terminal apparatus 10 that should be the destination of signal forwarding can be determined to be the forwarding role. That is, the terminal apparatus 10 is not assigned the forwarding role even if it satisfies the condition for transmission power and is located in the outer edge area of the communication area 100, unless the particular terminal apparatus 10 likely located outside the communication area 100 is nearby. Therefore, only the terminal apparatus 10 definitely capable of forwarding can be determined to have the forwarding role.

### Second Embodiment

The second embodiment differs from the first embodiment in that a plurality of predetermined areas are set within the communication area 100, and a threshold value is set in each predetermined area. Hereinafter, the difference from the first embodiment will be described.

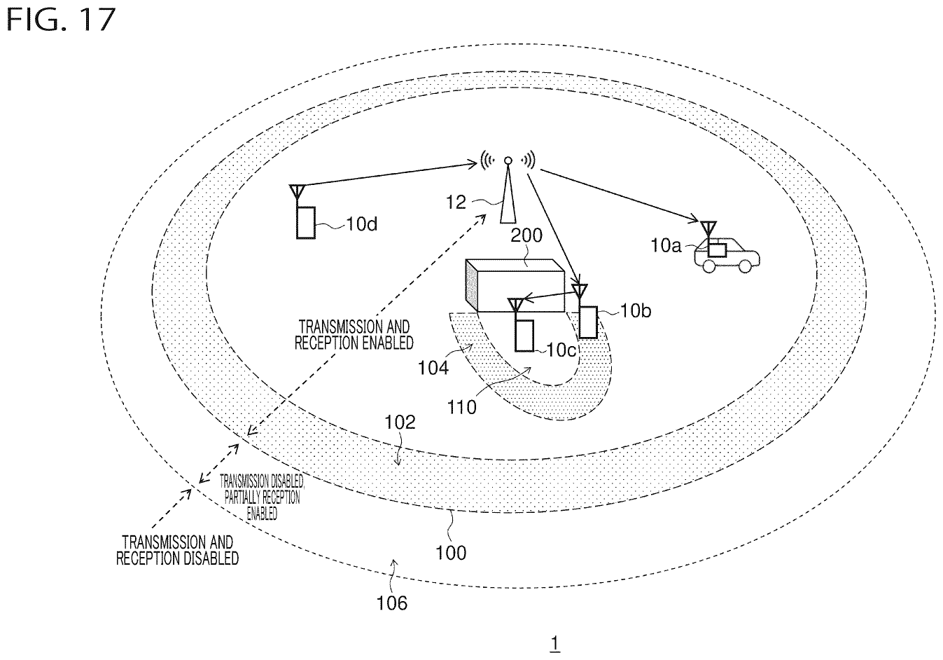

FIG. 17 shows a configuration of the communication system 1 of the second embodiment. There is an obstacle 200 such as a building within the communication area 100. A communication-disabled area 110 is set in advance in a part of the communication area 100 as a dead zone where communication is disabled due to the influence of the obstacle 200.

A further predetermined area 104 is also set in advance within the communication area 100. The further predetermined area 104 is an internal area located near the communication-disabled area 110. In this case, the further predetermined area 104 is contact with the communication-disabled area 110 within the communication area 100 and surrounds at least a part of the communication-disabled area 110. The position, extent, and number of further predetermined areas 104 can be appropriately determined by an experiment or simulation.

The further predetermined area 104 has a further preset threshold value associated therewith. The further threshold value is smaller than the threshold value for the predetermined area 102. The further threshold value is smaller than the transmission power of the second terminal apparatus 10b, etc. which is a mobile terminal. In the case the terminal apparatus 10 (not shown) having a transmission power smaller than the second terminal apparatus 10b is located, the further threshold value may be larger than the transmission power of that terminal apparatus 10.

The role determination unit 28 of the base station apparatus 12 assigns the forwarding role to the terminal apparatus 10, of the plurality of terminal apparatuses 10, having a transmission power larger than the threshold value and located in the outer edge area or to the terminal apparatus 10 having a transmission power larger than the further threshold value and located in the internal area.

In the example of FIG. 17, the first terminal apparatus 10a, the second terminal apparatus 10b, and the fourth terminal apparatus 10d are located in the communication area 100. The second terminal apparatus 10b is located in the further predetermined area 104 of the communication area 100. The third terminal apparatus 10c is located in the communication-disabled area 110.

For example, the audio signal transmitted by the fourth terminal apparatus 10d is received by the first terminal apparatus 10a and the second terminal apparatus 10b via the base station apparatus 12 but is not received by the third terminal apparatus 10c.

The base station apparatus 12 determines, from among the plurality of terminal apparatuses 10, the second terminal apparatus 10b having a transmission power larger than the further threshold value and located in the further predetermined area 104 to be the forwarding terminal. The second terminal apparatus 10b thus determined forwards the audio signal received from the base station apparatus 12 to the third terminal apparatus 10c. The third terminal apparatus 10c can receive the audio signal while remaining located in the communication-disabled area 110.

Since it is assumed that the communication-disabled area 110 within the communication area 100 is relatively narrow, the terminal apparatus 10 located in the internal area can forward the signal to the terminal apparatus 10 located in the communication-disabled area 110 even if the transmission power is smaller than the threshold value. By assigning the forwarding role to such a terminal apparatus 10, execution of forwarding is facilitated. It is thus possible to determine the terminal apparatus 10 suitable for forwarding depending on the situation.

A plurality of communication-disabled areas 110 may be set in advance within the communication area 100. In this case, the further predetermined area 104 for the communication-disabled area 110 is set in advance for each communication-disabled area 110. Further, a preset further threshold value is associated with each further predetermined area 104. The larger the area of the communication-disabled area 110, the larger the further threshold value associated with the further predetermined area 104 for the communication-disabled area 110. Thereby, the terminal apparatus 10 having an appropriate transmission power can be determined to have the forwarding role in accordance with the area of the communication-disabled area 110.

Further, the variation of the first embodiment may be combined with the second embodiment. That is, the second terminal apparatus 10b located in the internal area may not be determined to be the forwarding terminal when there are no terminal apparatuses 10 likely located in the communication-disabled area 110.

Given above is a description of the present disclosure based on the embodiments. The embodiments are intended to be illustrative only and it will be understood by those skilled in the art that various modifications to combinations of constituting elements and processes are possible and that such modifications are also within the scope of the present disclosure.

What is claimed is:

1. A base station apparatus comprising:
a communication unit that communicates wirelessly with each of a plurality of terminal apparatuses;
a state management unit that manages terminal information on each of the plurality of terminal apparatuses; and
a role determination unit that determines a role of the terminal apparatus,
wherein the state management unit:
transmits an information request signal requesting the terminal information to the plurality of terminal apparatuses from the communication unit;
receives, using the communication unit, the terminal information from the terminal apparatus in response to the information request signal, the terminal information including information on a transmission power and position information on the terminal apparatus; and
identifies a particular terminal apparatus likely located outside a communication area, based on past position information on the terminal apparatus from which the terminal information is not received in response to the information request signal,
wherein the role determination unit:
determines, from among the plurality of terminal apparatuses, the terminal apparatus having a transmission power larger than a preset threshold value and located in a predetermined area within a preset communication area of a host base station apparatus to have a forwarding role for forwarding a signal, based on the received terminal information; and
transmits, from the communication unit, a role change signal notifying the terminal apparatus, whose role is determined to be the forwarding role, that the forwarding role is assigned to the terminal apparatus.

2. The base station apparatus according to claim 1,
wherein the state management unit:
transmits a search request signal from the communication unit to the plurality of terminal apparatuses; and
receives, using the communication unit, the terminal information on a further terminal apparatus acquired by the terminal apparatus determined to have the forwarding role, from the terminal apparatus having the forwarding role in response to the search request signal.

3. The base station apparatus according to claim 1,
wherein the role determination unit:
among the terminal apparatuses from which the terminal information is received in response to the information request signal, determines the role of the terminal apparatus having a transmission power larger than the threshold value, located in the predetermined area, and likely located near the particular terminal apparatus to be the forwarding role.

4. A terminal apparatus comprising:
a terminal communication unit that communicates with the base station apparatus according to claim 2 and a further terminal apparatus;
a position information acquisition unit that acquires position information on a host terminal apparatus;
a storage unit that stores the terminal information on the host terminal apparatus, the terminal information including the position information and information on a preset transmission power;
a role management unit that, when the terminal communication unit receives the information request signal from the base station apparatus, transmits the terminal information from the terminal communication unit to the base station apparatus and that, when the terminal communication unit receives the role change signal transmitted when the base station apparatus determines that the terminal information satisfies a predetermined condition, sets the role of the host terminal apparatus to be the forwarding role; and
a forwarding unit that causes the terminal communication unit to forward a signal received from the base station apparatus to the further terminal apparatus, when the role of the host terminal apparatus is the forwarding role.

5. The terminal apparatus according to claim 4, comprising:
a control unit that controls an operation of the host terminal apparatus according to the role of the host terminal apparatus,
wherein the control unit:
when the role of the host terminal apparatus is the forwarding role,
transmits, when the terminal communication unit receives the search request signal from the base station apparatus, the search signal from the terminal communication unit to the further terminal apparatus; and
transmits, when the terminal communication unit receives a response signal from the further terminal apparatus in response to the search signal, the terminal information on the further terminal apparatus included in the response signal from the terminal communication unit to the base station apparatus.
